(19) United States
(12) Patent Application Publication
(10) Pub. No.: US 2007/0119829 A1
(43) Pub. Date: May 31, 2007

(54) Orbital welding device for pipeline construction

(75) Inventors: Eginhard Werner Vietz, Seelze (DE); Frank Vollertsen, Bremen (DE); Harald Kohn, Bremen (DE); Claus Thomy, Hambergen (DE)

Correspondence Address: ROTHWELL, FIGG, ERNST & MANBECK, P.C., 1425 K STREET, N.W., SUITE 800, WASHINGTON, DC, 20005, US

(73) Assignee: VIETZ GmbH, Hannover (DE)

(21) Appl. No.: 10/582,408

(22) PCT Filed: Dec. 10, 2004
(86) PCT No.: PCT/EP04/14089

§ 371 Date: Jun. 9, 2006

Related U.S. Application Data
(60) Provisional application No. 60/528,189, filed on Dec. 10, 2003.

(51) Int. Cl. B23K 26/28

(52) U.S. Cl. 219/121.63; 219/121.84; 219/61; 219/125.11

(57) ABSTRACT

The invention relates to an orbital welding device for mobile use in order to join a first pipe (1) and a second pipe end (2) along a circumferential joint (3) by at least one weld seam (4), particularly for producing a pipeline (5) to be placed on land. The inventive device includes a guide ring (6), which can be oriented toward the first pipe end (1) and the circumferential joint (3), and an orbital carriage (7) that can be motor-displaced along the guide ring (6) via an advancing device (8). On the orbital carriage (7), a laser welding head (12) for directing a laser beam (10) into a laser welding zone (13) is mounted in a manner that enables it to be oriented toward the circumferential joint (3) whereby enabling the production of the weld seam (4) along the circumferential joint (3) by displacing the orbital carriage (7). The laser beam (10) is produced by a high-power fiber laser beam source (9) located, in particular, on a mobile transport vehicle (35) while being situated at a distance from the orbital carriage (7), is guided by light guide (11) passing through a tube bundle (50) to the orbital carriage (7) and then supplied to the welding head (12). A significant advantage of the invention resides in the fact that the joining of two pipe ends by only one single welding process during a short period of time is made possible in the field with autonomous operation.

### CROSS-REFERENCE TO RELATED APPLICATION

This application is a National Phase of International Application Serial No. PCT/EP2004/014089, filed 10 Dec. 2004.

### FIELD OF THE INVENTION

The invention relates to an orbital welding device for joining pipelines by means of a circumferential weld seam, in particular for the orbital welding of pipelines during mobile use.

### DESCRIPTION OF THE BACKGROUND ART

Devices for welding pipes along the pipe circumference have long been known and are referred to as orbital welding devices. In the diameter range from 50 mm to more than 1500 mm and in the wall thickness range of from 2.5 mm to more than 25 mm, the mobile orbital welding methods have substantially replaced the previously used socket joint and screw joint technology. While most industrial welding units are operated in a stationary manner in industrial halls shielded from environmental influences or at least the welding work is carried out on a stationary product, the means of production move along the product to be completed in the case of line construction sites, for example for pipeline construction, and are thus exposed to all influences of the changing environment and of the different weather. Often, only a very limited infrastructure is available and it is therefore necessary completely to dispense with a fixed power, water and/or gas supply, as are taken for granted in the case of stationary industrial welding units, so that it is necessary to rely on mobile generators, mobile heat exchangers and transportable fluid and gas tanks, which are transported, for example, on at least one transport vehicle along the pipeline. The pipe welding work has to be carried out regularly alongside the pipe trench to be prepared or in the pipe trench itself with the pipe axis necessarily being horizontal. The construction site conditions resulting from different weather conditions, unfavourable ergonomic preconditions and the requirement for adaptation to different circumstances have a considerable influence on the quality of the welding result. Because of these circumstances, various welding techniques and welding methods which can be divided mainly into manual, partially mechanised or completely mechanised methods or a combination thereof have emerged. Criteria such as material, dimensions, intended use and cost-efficiency are decisive for the welding method chosen.

Purely manual methods are, for example, vertical-down metal arc welding using rod electrodes, arc welding characterized by great gap bridging ability and thicker individual weld layers using vertical-up welding technology, and arc welding using vertical-down welding technology. The latter permits a relatively high welding speed but, for carrying out the welding work in a satisfactory manner, requires an exact orientation of the pipe ends using suitable centring devices, a uniform air gap, little edge misalignment and the avoidance of excessively high cooling rates of the individual layers. A fully trained vertical-down welder, suitable centring devices, good welding electrodes and suitable welding power supplies which generate a linear direct current are indispensable for the economical use of the vertical-down welding technology.

Although in low-wage countries where the wage is scarcely a significant factor pipelines are still welded manually by the vertical-down method, often with technically obsolete welding machines, and the quality of the weld seams is therefore dependent in particular on the qualification and daily form of the welder, a large number of automatic or semiautomatic welding methods have in the meantime been developed. A very widely used and relatively economical method in pipeline construction is MAG orbital welding technology. The acronym MAG represents metal active gas welding, which is known from the prior art and in which an arc burns between a melting and substantially continuously fed wire electrode and the workpiece within a shielding gas blanket comprising, for example, CO₂ or mixed gas comprising CO₂, inert gas e.g. argon and possible also O₂. Depending on the speed of laying of the pipeline, the pipe diameter, the wall thickness of the pipe, the nature of the terrain, the ambient temperatures, the available infrastructure and the qualification of the skilled labour, substantially four different variants, which are described below, have become established in the prior art.

In the first variant—the most economical but also slowest variant which is therefore suitable in particular for short pipeline construction sites—the pipes are centred and fixed without pre-treatment with an air gap of 1.5 mm to 3 mm by means of pneumatic internal centring. First, the root is welded manually from top to bottom using a cellulose or basic electrode or using an MAG welding device with 1.0 mm metal powder wire. After completion of the root, a retaining strap is locked around the pipe close to the joint at which all intermediate layers and the cover layers are welded from bottom to top with a flux cored wire using two MAG orbital welding heads which each have an MAG torch. A shielding gas comprising CO₂ and argon is used for the welding process. The first welder begins at the 6 o'clock position and welds all filling and cover layers up to the 12 o'clock position alternately on the left and right with dwell times. The second welder begins after a time lapse, likewise at the 6 o'clock position and welds up to the 1 o'clock position in order to obtain an overlap of the weld seam. This variant can be used for the laying of district heating pipes in tunnel construction, water pipes in tunnel construction and also for gas stores of relatively large dimensions, for example 2500 mm diameter, but especially for wall thicknesses between 15 mm and 30 mm. The deposition efficiency is 3.1 kg per hour. Compared with vertical-down welding using cellulose electrodes at 1.7 kg per hour, this variant is twice as fast.

The second established variant, which is substantially faster than the first variant, requires greater capital costs. In order to be able to weld according to this variant, a facing machine with a hydraulic unit is required for processing the pipe ends. All pipes have to be lifted individually at the construction site by means of a sideboom so that they can be introduced into the facing machine in order to equip the pipe ends appropriately with a special weld seam preparation. The joint shape corresponds to a tulip having a root of about 2 mm with a small opening angle, little filler material being required owing to the small seam volume. In order to control the root welding qualitatively from the outside, it is necessary to use a pneumatic internal centring device with copper shoes. The function of the copper shoes is to support the liquid weld metal in order to achieve a one hundred percent root in which both pipe inner edges are welded to one another and a drop-through of not more than 1 mm at the root is ensured. After the pipe ends have been processed, the pipe is centred by means of the pneumatic internal centring with copper shoes. Beforehand, a retaining strap on which two MAG orbital welding heads are guided is mounted on one of the pipe ends, which MAG orbital welding heads weld the root from 12 o'clock to 6 o'clock. The pipe ends are centred without an air gap so that, beginning at 12 o'clock, the first MAG orbital welding head melts the root at a high power and the liquid weld metal is supported by the copper shoes. The second MAG orbital welding head likewise starts at 12 o'clock when the first MAG orbital welding head has reached the 2 o'clock position. In order to avoid defects in the root, the power supply for the inverter or rectifier is so constant that the welding parameters do not change during switching on of the second MAG orbital welding head. This is ensured in particular by means of a hydraulic generator drive which is present on the transport vehicle moved along the pipeline and which reacts within milliseconds in order to maintain the stability of the arc. If appropriate, it is possible to program the welding power sources for the various welding positions—horizontal, vertical-down and overhead - so that, depending on the position of an MAG orbital welding head, power adaptation and adaptation of the wire feed speed can be effected in each case. The adaptation is effected fully automatically, semi-automatically or manually. The two MAG orbital welding heads weld the seam according to the same criteria from top to bottom. After completion of the second layer the MAG orbital welding heads are removed from the retaining strap and transported to the next joint. A subsequent pair of MAG orbital welding heads welds a plurality of filling layers in a non-oscillating manner, likewise from top to bottom. Depending on the wall thickness of the pipe, up to 5 such welding stations can be used at intervals along the pipeline, altogether 10 MAG orbital welding heads being in use, in some cases simultaneously, and being required. Welding is effected with solid wire, and a different gas composition is used depending on the welding layer. It is advisable to install an automatic gas mixing unit on the mobile transport vehicles or to use gas from cylinders in which the mixture is delivered in the form ready for use. The deposition efficiency of this variant is usually up to 5.1 kg per hour using solid wire, which represents a substantial increase in the welding speed and the daily performance. The weld seam quality is good to very good. A maximum repair rate of 3 to 5% is stated.

For the third variant, an internal MAG orbital welding head is required in order to weld the root from the inside. Four MAG welding torches weld—beginning from the 12 o'clock position to 6 o'clock—the root of one half of the pipe in an overlapping manner and four MAG welding torches weld the other half of the pipe from top to bottom. The welding of the root on a 1200 mm pipe takes about 3 minutes. In order to achieve this high welding speed, the capital costs are correspondingly high. The welding of the filling and cover layer is effected as in the second variant using solid wire, from top to bottom. Control takes place manually, semi-automatically or, in the case of programmable power supplies, automatically, depending on the degree of qualification of the operator. The deposition power in this method is usually 5.9 kg per hour, so that this method is the fastest but also the most expensive orbital welding method compared with the preceding ones.

A fourth variant envisages equipping one MAG orbital welding head in each case with two MAG torches slightly offset around the pipe circumference and two or four wires. The welding speed increases by about 100% if welding is effected with two MAG torches, or by about 400% if welding is effected with two MAG torches and four wires. This technology is particularly suitable for pipes that have a diameter greater than 1,000 mm and which have a wall thickness of at least 20 mm. The weld seam preparation is adjusted accordingly. Altogether, eight welding power supplies, which are arranged, for example, on the transport vehicle, are required in order to be able to operate two MAG orbital welding heads which are guided on a retaining strap as described above and have in each case four wires. The power supplies communicate with one another and pulse synchronously. This is possible, for example, by means of a special multi-inverter. In order to be able to use such MAG orbital welding heads, having a total of four torches extensive training of the operator is required. The respective construction site criteria must be taken into account in order to achieve the desired daily performance by this method. The capital costs are considerable, but a very high deposition efficiency and welding speed are achieved.

In order to achieve optimum welding results in all four variants of the MAG orbital welding, the welding process takes place in each case under a suitable welding tent. The welding tent is designed so that no air draught can enter the tent during the welding process. Furthermore, the doors of the welding tent are secured in such a way that no access by unauthorised persons from the outside is possible during the welding work. In the case of extreme thermal conditions, the welding tents are air conditioned so as to be free of draughts. The welding seam quality depends to a great extent on the design of the welding tent. All four MAG orbital welding variants described above are technically mature but require that all boundary conditions be complied with in order to produce first-class weld seems.

MAG orbital welding has encountered its limits through high repair rates, downtimes due to weather influences and impairment of the weld seam quality due to the operator. The operator of the MAG orbital welding heads must be highly qualified not only in the welding technology sector but also in the electronics sector. Welding parameters which fully automatically influence the welding process in the various welding positions have the disadvantage that external changes—in particular splashes which can form in an uncontrolled manner during welding—or atmospheric influences—require the welder to intervene immediately in the automated process and manipulate the welding process in order to minimise the errors. The welding of the root using internal MAG orbital welding heads is very fast but also very expensive. Moreover, the root layer is often associated with very many welding defects. At the beginning of a root, it is possible for pores to form on starting, which pores form into the upper weld layer on welding over with a subsequent torch. These pores have to be mechanically eliminated after the welding. It is therefore necessary for the welder to re-weld the root from the inside and using a manual welding device. Only thereafter can further welding processes take place from the outside. The high capital costs and the large number of well trained personnel required have therefore prevented this method from achieving a breakthrough. These problems have become even more extensive when two or four wires are used on a welding head.

Since for completing a weld seam, a large number of filling layers, some of which require the use of different MAG orbital welding heads, have to be welded in addition to the root and the cover layer, as a rule a plurality of welding stations, in some cases over five welding stations are used for achieving a high laying speed of the pipeline, by means of which welding station in each case a weld seam or a plurality of weld seams is produced. Since work is thus carried out simultaneously on a plurality of pipe joints, a plurality of completely equipped welding stations have to be provided, which in each case require not only a plurality of MAG orbital welding heads but also in each case shielding, in particular in the form of a welding tent, a transport vehicle transporting the respective welding power supply, the shielding gas cylinders, the generator, optionally the welding wire and further supply devices, and a plurality of pipe cranes. This leads not only to considerable capital costs but also results in a major maintenance effort and high personnel costs, since each welding station has to be operated by appropriately qualified personnel.

Owing to these problems in the prior art of mobile MAG orbital welding of pipelines, alternative joining methods for pipeline construction have long been researched worldwide.

A welding method which has proved its worth in stationary use is laser beam welding. At present, high-power CO₂ gas lasers, high-power Nd:YAG solid-state lasers, high-power disc lasers and high-power diode lasers are used in laser beam welding. The high-power laser is to be understood as meaning a laser beam source having a beam power of at least 1 kW.

CO₂ lasers emit laser light having a wavelength of 10.6 μm and, in material processing, have beam powers from a few hundred watt to over 40 kW with an efficiency of about 10%. The beam guidance in the case of such CO₂ lasers must be effected by means of relatively complicated optical mirror systems since beam guidance by means of a flexible waveguide is not possible owing to the wavelength of the laser light emitted.

The laser light emitted by a Nd:YAG laser has a wavelength of 1.064 μm, industrially available, lamp-pumped systems for material processing having a beam power of about 10 W to more than 6 kW in continuous wave operation. By using diode arrays for excitation instead of arc lamps, an increase in the efficiency by 3% for a lamp-pumped system up to about 10% is possible, but with considerably higher capital costs. In contrast to the CO₂ laser beam, a beam produced by an Nd:YAG laser can be guided via waveguides, in particular a fibre optic cable, which permits a considerably more flexible arrangement of the beam source and handling of the Nd:YAG laser beam.

A more recent development in the area of solid-state lasers is the disc laser. The light of this laser can be guided in the same way as that of the Nd:YAG laser, by means of fibres. What is particularly advantageous in the case of this laser is the high efficiency in the region of 20%. However, its beam power is currently limited to 4 kW.

The wavelength of diode lasers is between 0.78 and 0.94 μm, depending on the doping of the semiconductive material used, beam powers up to 4 kW in the fibre-coupled mode or 6 kW in the direct-emitting mode being industrially available at an efficiency of 35 to 50%.

However, these four laser beam sources used in the case of laser beam welding have not been successfully used to date in the mobile orbital welding of pipes, in particular pipelines.

Since the beam emitted by a CO₂ laser can be deflected only by means of mirrors and the beam guidance is thus extremely difficult, CO₂ lasers have been used to date in practice only in stationary operation or in the off-shore sector on ships, either the pipes to be joined being rotated relative to the stationary laser beam in the case of a stationary laser beam source or the entire laser beam source being pivoted by means of a stable device about the upright stationary pipe. Such devices are shown, for example, in U.S. Pat. No. 4,591,294, which describes an orbital welding device having two CO₂ lasers which are arranged on a rotatable platform and can be pivoted in each case through 180° about a vertical pipeline section to be let into the sea from a ship, in such a way that a circumferential weld seam can be produced. In the case of horizontal laying of long pipelines on land the rotation of the pipeline with a stationary laser beam is ruled out. Pivoting of the entire CO₂ laser about a horizontal pipe by means of mobile devices is not possible with the required precision under field conditions owing to the great weight and the size of a high-power CO₂ laser. Guidance of the laser beam around a stationary pipe, preferably through more than 180°, so that the beam always strikes the outer surface of the pipe substantially perpendicularly is very complicated since mirror systems having a multiplicity of joints have to be used. A mirror system by means of which a laser beam guided parallel to the pipe axis outside the pipe can be guided via five mirrors which are arranged in a multi-limb and multiply adjustable laser guidance pipe system around a circumferential joint of two pipe ends is disclosed in Russian laid-open application RU 2 229 367 C2. U.S. Pat. No. 4,533,814 shows a similar system in which a laser beam directed perpendicularly on to the pipe axis can be guided via a steel guide pipe system, which comprises three joints and a plurality of mirrors, around a pipe of relatively small diameter. A further mirror system is described in U.S. Pat. No. 4,429,211, in which a laser beam is deflected via adjustable mirrors, partly unshielded, to a working head which runs around a circumferential joint and in turn directs this beam on to the circumferential joint. Common to the known mirror systems is that, owing to the large space requirement, the great weight, the high capital costs and the high sensitivity with respect to soiling, misadjustment or damage to the mirrors, they are unsuitable for mobile use under field conditions. Internal circumferential welding by means of a CO₂ laser beam coaxial with the pipe axis is possible, but to date only unsatisfactory results have been achieved by internal circumferential welding of pipelines without additional external circumferential welding. A further problem of the CO₂ laser is its poor efficiency and the associated high energy and cooling requirement. Since power has to be generated as a rule by mobile generators in field use, sufficient power supply for high-powered CO₂ lasers is problematic. Furthermore, owing to the great evolution of heat, it is necessary to use large cooling systems, which additionally complicate the mobile use of a CO₂ laser. Owing to the relatively high sensitivity of a CO₂ laser to vibrations, mobile use is scarcely possible.

Owing to the suitability of the emitted laser beam for beam guidance via a flexible waveguide, an Nd:YAG laser would be suitable for guiding the beam around a pipe of large diameter but this laser source, like the CO₂ laser proves to be unsuitable for mobile field use. Owing to the poor efficiency of an Nd:YAG laser compared with other industrial lasers, the power supply and the space requirement of the laser and its additional components, in particular the cooler, present a still unsolved problem for use in the mobile orbital welding of pipelines. The sensitivity of an Nd:YAG laser to vibration is also relatively high. Moreover, no completely satisfactory welding results have been achieved to date even in stationary use with the Nd:YAG laser, owing to the lower laser beam power compared with the CO₂ laser, since the maximum achievable welding speed in the welding of large pipes, in particular for a pipeline, is too low and single-pass welding cannot be effected.

The beam power of the disc laser is currently limited to not more than 4 kW which, in view of the beam properties of a disc laser, is to be regarded as insufficient for the orbital welding of the thick-walled pipes. In spite of its high efficiency in the region of 20% and the associated relatively low power requirement, the disc laser is currently by no means suitable as a mobile laser source which is inevitably exposed to vibrations under field conditions, owing to its design which is difficult to adjust and its extremely high sensitivity to vibrations.

In contrast to high-power CO₂ lasers, high-power Nd:YAG lasers and high-power disc lasers which, owing to energy and space requirements and design and weight can be operated at all as mobile systems only with very great limitations, the diode laser is a relatively mobile, compact and light laser beam source with good efficiency. However, owing to its fundamental lower beam intensity and beam power the diode laser as a rule does not permit deep welding under normal conditions so that the welding of thick-walled pipes will be possible only by the multi-pass technique.

U.S. Pat. No. 5,796,068 and U.S. Pat. No. 5,796,069 describe a laser outer circumference welding device for pipeline construction. The device comprises at least one outer annular guide rail fixed on a pipe of the pipeline, a welding carriage guided on said guide rail and movable around the pipe, a laser beam source mounted on the welding carriage and intended for generating a laser beam, which optionally can be directed by deflection means onto the joint formed by the pipe ends to be connected and abutting one another, and a feed unit likewise mounted on the welding carriage and intended for orbital movement of the welding carriage around the pipe, so that the laser beam is guided along the join of the pipe ends abutting one another for joining said ends by means of an outer circumferential weld seam. Since the laser beam source is arranged directly on the welding vehicle and has to be moved around the entire pipe, considerable limitations in the choice of a beam source suitable for this purpose result. A solid-state or gas laser suitable with regard to size and weight has much too low a beam power to achieve a welding speed which corresponds to at least that in arc welding. A diode laser would under certain circumstances be suitable with regard to its size for direct mounting on the transport carriage, but, owing to its fundamental low beam intensity, it does not permit deep welding of thick-walled pipes without the use of the mulfi-pass technique.

In addition, U.S. Pat. No. 5,796,068 and U.S. Pat. No. 5,796,069 describe a combined laser inner circumference welding and inner centring device. The device is in the form of a vehicle which is movable by means of a drive inside the pipe along the pipe axis and can thus be positioned in the region of the join formed by the pipe ends which are to be joined and which abut one another. With the aid of an integrated inner centring unit which has two pneumatic clamping devices acting in each case radially on the inner surface of a pipe, the two pipes can be aligned exactly with one another in a known manner. In a subsequent step, at least one laser beam emitted by a laser beam source mounted on the pipe vehicle is guided along the join for joining the two pipe ends by means of an inner circumferential weld seam. Furthermore, a method is described in which first a weld layer is welded from the inside by means of an arc and subsequently a weld layer is welded from the outside by means of a laser.

WO 92/03249 discloses a device for the laser welding of a pipe along its inner circumference using a probe which can be introduced into the pipe. Arranged inside the probe are means with which a part of a shielding gas stream propagating in its interior is branched off before reaching an outlet orifice for a focused and deflected laser beam supplied in particular by an Nd:YAG laser a distance away by means of a waveguide and fed, with a flow component directed towards the outlet orifice, to the outer surface of the probe. As a result, a deposit of weld metal in the region of the outlet orifice and in the interior of the probe is reduced.

U.S. Pat. No. 5,601,735 presents a laser welding device for the production of an elongated, tubular and gas-tight earthing cylinder housing to be filled with the insulating gas SF6 and comprising a large number of short cylinder segments connected to one another via an outer circumferential weld seam and intended for an electrical component, for example a power switch or load-interrupter switch. The laser welding device comprises an annular frame which is arranged around the circumferential joint by means of two retaining straps firmly enclosing the two cylinder segments to be connected, in each case close to the cylinder ends. Since the distance between the two retaining straps connected to one another via the annular frame is adjustable by means of a large number of longitudinal adjusting screws and both retaining straps can be axially aligned relative to the cylinder segments by means of a plurality of radial clamping screws distributed along the circumference, it is possible to align the two cylinder segments relative to one another. Present within the annular frame is an annular rail along which is guided a laser welding tool which can be moved around the circumferential joint by means of an electric motor mounted on the annular frame and engaging a gear ring arranged on the laser welding tool. The laser welding tool comprises a focusing optical system for focusing a laser beam onto the circumferential joint, detectors for detecting the position of the circumferential joint and two drives for precision alignment of the focussing optical system with the circumferential joint in the radial and axial direction. The laser beam is produced by means of a laser beam source positioned in the vicinity of the annular frame and is passed via a fibre optic cable to the focussing optical system. The fibre optic cable is wound inside the annular frame via a spiral rail around the two pipes so that, during movement of the laser welding tool around the entire pipe circumference, extension of, or other damage to, the fibre optic cable should be prevented. In spite of the glass fibre used, a CO₂ laser is mentioned as possible laser beam source. The welding device described in U.S. Pat. No. 5,601,735 is designed for joining relatively short cylindrical segments of small diameter, small wall thickness and relatively light weight, which takes place in stationary use, as is the case for earthing housings of the generic type for power switches or load-interrupter switches. Since the production of such products always takes place in a stationary manner, the question of mobile operation of the device disclosed in the generic manner does not arise, and it is for this reason that appropriate measures are not described. The use of such a welding method for the welding of long pipes of large diameter up to more than 1500 mm and wall thicknesses of up to about 25 mm, for example pipelines, at high welding speed is not possible by means of the welding device described, which is designed only for low laser powers. The guidance of the laser beam of a CO₂ laser source by means of a fibre optic cable, as described in U.S. Pat. No. 5,601,735, is not possible with the use of a high-power CO₂ laser source having a laser power of more than 1 kW.

### SUMMARY OF THE INVENTION

The object of the invention is therefore to provide a device for the orbital welding of pipelines by means of a circumferential weld seam which has only one layer or as few layers as possible, in particular for the orbital welding of pipelines laid horizontally on land in mobile use under field conditions, by means of which device it is possible to achieve higher welding speeds than in MAG orbital welding, greater process reliability and a high weld seam quality.

This object is achieved by realising the characterizing features disclosed herein. Features which further develop the invention in an alternative or advantageous manner are also described herein.

The orbital welding device according to the invention is suitable for mobile use for joining a first pipe end and a second pipe end along a circumferential joint by means of at least one weld seam, in particular for producing a pipeline to be laid horizontally on land, but also for stationary use or offshore use at sea for non-horizontal pipe orientation. By means of the orbital welding device according to the invention, it is possible to join pipes which consist of a fusion-weldable material, in particular a metallic material, preferably a steel material, e.g. X70, X80, X90, X100 or high-alloy, stainless steel and have a diameter of 50 mm to more than 4000 mm and a wall thickness of 2.5 mm to more than 25 mm, within a short time using only one orbit. Although it is possible to use the device for smaller pipes, the pipe segments to be joined have, in the preferred applications, a diameter of more than 500 mm, in particular more than 800 mm, especially more than 1000 mm, a wall thickness of more than 5 mm, especially more than 10 mm, and a length which is substantially greater than the diameter of the pipe. Because of the suitability for mobile and stand-alone use, the device according to the invention can also be used for producing pipelines to be laid horizontally on land in an environment in which only a poor infrastructure or no infrastructure in the form of a fixed power, water or gas supply is available.

The orbital welding device comprises a guide ring which can be oriented relative to the pipe end of a first pipe, referred to below as the first pipe end, and the circumferential joint. The circumferential joint is defined as the gap or zero gap between the end faces of the first pipe end and of the pipe end of a second pipe of equal cross-section, referred to below as the second pipe end, or is defined as the pipe joint, the first pipe and the second pipe being aligned with one another so that the circumferential joint has a substantially constant gap width of not more than 1 mm, preferably less than 0.3 mm, particularly preferably a technical zero gap, and the two pipes are centred relative to one another without substantial misalignment. The two pipes preferably have a circular cross-section but alternatively an ellipsoidal or other cross-section and are in particular straight, curved or angled. Devices for centring pipes from the inside and/or outside and for establishing a defined gap width of the circumferential joint are known from the prior art in various embodiments. The pipe ends are processed, in particular with the aid of a known facing device, so that the circumferential join has the form of a plain butt weld, a Y weld, a V weld or a U weld. Alternatively, the edges are laser-cut. The guide ring is preferably aligned parallel to the circumferential joint with a constant distance from the outer surface or inner surface of the first pipe end. The alignment is effected, for example, by means of a multiplicity of clamping screws which are arranged along the guide ring circumference by means of which the distance of the guide ring from the pipe surface can be exactly adjusted.

The guide ring serves for guiding an orbital carriage which is arranged on said ring and is displaceably guided orbitally either along the total outer or inner circumference of the first pipe end or at least along a section of the circumference. The orbital carriage can be moved under motor power by means of a feed device along the guide ring.

A laser welding head for guiding and shaping a laser beam is arranged on the orbital carriage. The laser welding head can be aligned with the circumferential joint so that the material of the two pipe ends can be fused within the thermal zone of influence of the laser beam, referred to below as laser welding zone, by means of a laser beam focussed by the laser welding head onto the circumferential joint or onto a point present in the immediate vicinity of the circumferential joint, if appropriate with supply of inert or active process gasses or mixtures thereof, and a weld seam can be produced along the circumferential joint by moving the orbital carriage along the guide ring, if appropriate with supply of a filler material in the form of a wire. If appropriate, means for supporting the weld pool or forming are provided, in particular copper shoes on the opposite side or a feed device for supplying forming gas on the root side.

According to the invention, the laser beam is produced by means of at least one mobile high-power fibre laser beam source which is arranged a distance away from the laser welding head—in particular with vibration damping on a transport vehicle movable outside the pipe longitudinally relative to the pipe axis. The laser beam produced by the fibre laser is guided by means of a waveguide, preferably a flexible fibre optic cable, from the high-power fibre laser beam source to the laser welding head. It is possible to use a waveguide having a length of 30 m to more than 200 m so that the transport vehicle can be positioned with the high-power fibre laser beam source a long distance away from the laser welding head.

A high-power fibre laser beam source in the context of the invention is to be understood as meaning a solid-state laser beam source which has a beam power of more than 1 kW, in particular more than 3 kW, preferably more than 5 kW, particularly preferably more than 7 kW, depending on the field of use, and the laser-active medium of which is formed by a fibre. The fibre consisting in particular of yttrium aluminium garnet is as a rule doped with ytterbium or other rare earth metals. The ends and/or the lateral surface of the glass fibres are optically pumped, for example by means of diodes. The wavelength of a typical high-power fibre laser beam source is about 1.07 μm, an efficiency of more than 20% of beam powers of theoretically up to more than 100 kW being available. Thus, the efficiency of a high-power fibre laser beam source is substantially higher than that of an Nd:YAG laser or of a CO₂ laser. The maximum achievable beam power is currently substantially higher than that of the Nd:YAG laser or of the diode laser. The beam intensity surpasses that of the diode laser, so that deep welding is possible. In comparison with the CO₂ laser, Nd:YAG laser and disc laser, a high-power fibre laser beam source is relatively insensitive to vibrations. In contrast to the CO₂ laser, a laser beam produced by a high-power fibre laser beam source can be passed via a flexible fibre optic cable over distances of up to 200 metres. The high-power fibre laser beam source permits both production of continuous laser radiation in so-called cw operation and the production of pulsed laser radiation having pulse frequencies of up to more than 20 kHz and arbitrary pulse shapes. In particular, because of the excellent efficiency compared with the Nd:YAG laser, which requires a relatively low generator power and a relatively small cooling system, the high available beam power and the outstanding beam quality, which, in comparison with the diode laser, permits deep welding, the suitability for waveguide beam guidance, the low sensitivity to vibrations and small size of a high-power fibre laser beam source compared with the Nd:YAG laser and CO₂ laser, mobile and stand-alone use on a transport vehicle is possible.

As tests have shown, it is possible to join pipes which have a wall thickness of 12 mm or 16 mm, are made of X70 steel and have a circumferential joint in the form of a V seam, prepared by laser beam cutting and having a very small opening angle of only about 1°, at a welding speed of 2.2 or 1.2 metres per minute at a currently commercially available beam power of 10 kW, a beam parameter product of 12 mm·mrad and a beam diameter in the focal area of about 0.3 mm by means of the orbital welding device according to the invention, the on-spec weld seam produced thereby having only a single weld layer. Thus, welding speeds of less than 3 minutes for joining two typical pipeline segments having a normal diameter of 1000 mm are possible in mobile use under field conditions.

A substantial advantage of the invention is that the joining of two pipe ends is possible by means of only one orbit and preferably a single welding process within a short time. The necessity of using a multiplicity of different welding stations operating at a plurality of joining points along the pipeline and welding different weld layers, which has existed to date for economic reasons in the horizontal laying of pipelines under field conditions with MAG orbital welding, is dispensed with since complete joining of two pipe segments is possible by means of a single welding station. The transport of a multiplicity of welding stations and the associated costs are dispensed with. Substantially fewer personnel are required than in the case of the methods known to date. The weld seam quality and the process reliability surpass those of the MAG orbital welding devices known to date. Of course, for further increasing the production speed, it is possible to use a plurality of laser welding heads, which operate on a circumferential joint or are employed in different welding stations. The use of a single high-power fibre laser beam source for a plurality of laser welding heads or a plurality of high-power fibre laser beam sources for one laser welding head is possible. It is also possible to combine the orbital welding device according to the invention with elements of already known orbital welding devices, for example an MSG orbital welding device already known from the prior art.

In a further development of the invention, an MSG arc welding head which in particular can be aligned under motor power relative to the orbital carriage is arranged indirectly or directly on the orbital carriage. An MSG arc welding head is to be understood in general as meaning a metal shielding gas welding head, in which an arc burns between a wire electrode, which is guided continuously by means of a wire feed, and the workpiece and is surrounded by a shielding gas blanket. The MSG arc welding head is mounted on the orbital carriage, either directly or indirectly, for example on the laser welding head, and in particular can be adjusted relative to the orbital carriage in a plurality of directions. It is possible to arrange the MSG arc welding head in such a way that either the laser beam and the MSG arc act together in the laser welding zone or the laser beam and the MSG arc act in separate process zones.

### BRIEF DESCRIPTION OF THE DRAWINGS

The device according to the invention is described in more detail below, purely by way of example, with reference to specific working examples which are shown schematically in the drawings and are not to scale, further advantages of the invention also being discussed. Specifically:

FIG. 1 shows a first embodiment of an orbital welding device comprising an orbital carriage, a laser welding head for joining a first pipe end and a second pipe end and a transport vehicle in an oblique overview;

FIG. 2 shows the orbital carriage with the laser welding head in a detailed view transversely to the pipe axis;

FIG. 3 shows the orbital carriage with the laser welding head, a wire nozzle and a process gas nozzle in a detailed view A-A parallel to the pipe axis;

FIG. 4 shows a second embodiment of an orbital welding device comprising an orbital carriage, a laser welding head, an MSG arc welding head and a transport vehicle in an oblique overview; and

FIG. 5 shows the orbital carriage with the laser welding head and the MSG arc welding head in a detailed view parallel to the pipe axis.

### DETAILED DESCRIPTION OF THE INVENTION

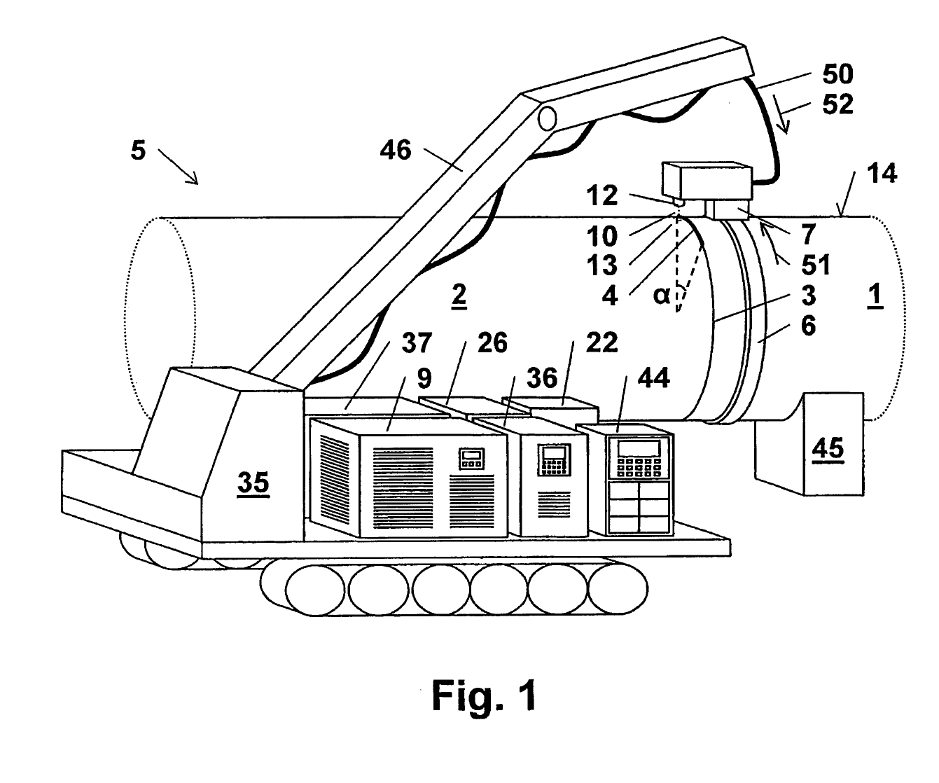

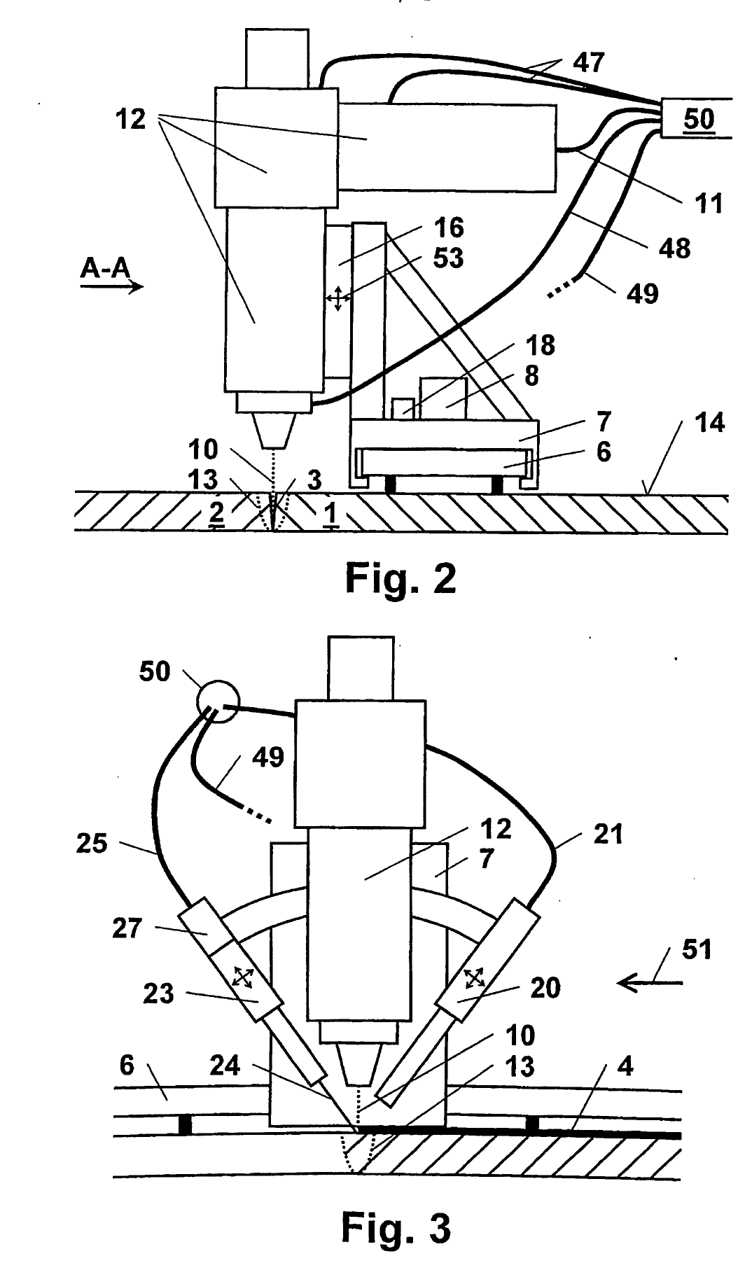

A first embodiment of the invention is shown in FIGS. 1, 2 and 3 in different views and degrees of detail. FIG. 1 shows the entire orbital welding device in an oblique overview of a pipeline construction site. A first pipe end 1 and a second pipe end 2 of a pipeline 5 to be laid horizontally on land are aligned and centred by means of a known inner centring device which is not shown, at least one pipe crane (not shown) and pipe supports 45, in such a way that a circumferential joint 3 having a defined gap width of less than 0.3 mm and no misalignment of edges is present between the first pipe end 1 and the second pipe end 2. A guide ring 6 in the form of a retaining strap having a guide rail is arranged on the first pipe end 1, parallel to the circumferential joint 3 and at a constant distance from the outer surface 14 of the first pipe end 1. An orbital carriage 7 which is displaceably guided under motor power around the first pipe end 1, as indicated by the arrow 51, along the guide ring 6 is present on the guide ring 6. Mounted on the orbital carriage 7 is a laser welding head 12 which can be aligned with the circumferential joint 3 in such a way that a weld seam 4, in this case an outer weld seam 4, can be produced along the circumferential joint 3 by directing a laser beam 10 focussed by the laser welding head 12 into a laser welding zone 13 and moving the orbital carriage 7 to an orbit under motor power. The height of the pipe support 45 is chosen so that movement of the orbital carriage 7 through 360° around the first pipe end is possible. The laser beam 10 is produced by a high-power fibre laser beam source 9 which is housed with vibration damping, a distance away from the orbital carriage 7 on a transport vehicle 35. The laser beam 10 produced is guided by means of a flexible waveguide 11 (cf. FIG. 2), which is led from the high-power fibre laser beam source 9 to the laser welding head 12 in a tube bundle 50 which is guided to the orbital carriage 7 by means of a crane 46 of the transport vehicle 35. The tube bundle 50 is carried along by means of the crane 46, as indicated by the arrow 52, so that the orbital carriage 7 can be moved without hindrance. The crane 46 can furthermore be used for mounting the guide ring 6 and the orbital carriage and for holding a shielding device (not shown) which shields the welding point from the environment and vice versa, firstly to protect the operator from dangerous reflections of the laser beam and secondly to keep draughts, moisture and impurities away from the welding point. Moreover, a generator 36 at least for producing the power required for operating the high-power fibre laser beam source 9 and a cooling system 37 at least for cooling the high-power fibre laser beam source 9 are arranged on the transport vehicle. Further reference numerals of FIG. 1 will be discussed below in the description of the other Figures. Furthermore, reference will be made to reference numerals of preceding Figures in the description of the following Figures.

FIG. 2 shows the orbital carriage 7 from FIG. 1 which is displaceably mounted on the guide ring 6, in a simplified detailed view transversely to the pipe axis. Arranged on the orbital carriage 7 is a feed device 8 which engages the guide ring 6 in such a way that the orbital carriage 7 can be moved orbitally by means of an electric motor at a defined feed speed around the first pipe end and the circumferential joint 3, which is formed by a V butt joint having a very small opening angle. In order to be able to detect the orbital position a of the orbital carriage 7 relative to a reference position, an orbital position sensor 18 which, for example, is in the form of an electronic angle encoder is mounted on the orbital carriage 7. The laser welding head 12 is mounted on the orbital carriage 7 via adjusting means 16, by means of which the laser beam 10 can be oriented relative to the circumferential joint 3 by adjusting the entire laser welding head 12 relative to the orbital carriage 7. The adjusting means 16, which, for example, are servo motors, permit, as indicated by the arrows 53, both adjustment of the laser welding head 12 perpendicular to the pipe so that, for example, the focal position can be adjusted, and an adjustment parallel to the pipe axis for exact alignment of the laser beam 10 with the circumferential joint 3. Alternatively, it is of course possible to design the adjusting means 16 so that the laser welding head 12 is adjustable in further degrees of freedom or the laser beam 10 is adjustable additionally or exclusively by an optical method, for example via a focusing or deflection unit of the laser welding head. The waveguide 11 led in the tube bundle 50 to the orbital carriage 7 guides the laser beam 10 emitted by the high-power fibre laser beam source 9 to the laser welding head 12 which focuses the laser beam 10 onto the circumferential joint 3 or onto a point close to the circumferential joint 3, so that the material of the first pipe end 1 and of the second pipe end 2 within a thermal zone of influence of the laser beam 10, the laser welding zone 13, melts and forms a weld seam 4. Since the laser welding head 12 is subjected to a high thermal load, a cooling/heating circulation 47 with forward and return flow, which supplies all parts of the laser welding head 12 which are to be cooled or heated or further parts arranged on the orbital carriage 7 with cooling or heating fluid of the cooling system 37 present on the transport carriage, is housed in tube bundle 50. A communication line 49 in the tube bundle 50 in the form of a cable supplies in particular current to the feed unit 8 and permits communication of all sensors and actuators arranged indirectly or directly on the orbital carriage 7 with a control computer 44 which is present on the transport vehicle 35 and controls and monitors the entire welding process. In order to protect the laser welding head 12 from splashes or other impurities compressed air delivered from the transport vehicle 35 is passed via a compressed air line 48 in the tube bundle 50 to the laser welding head 12 so that in particular a protective screen arranged in front of the focussing optical system of the laser welding head 12 can be supplied with a constant stream of compressed air.

FIG. 3 shows the laser welding head 12 in a detailed view A-A according to FIG. 2 parallel to the pipe axis. A process gas nozzle 20 for supplying process gas in the region of the laser welding zone 13 is mounted indirectly on the orbital carriage 7, on the laser welding head 12. The supply of the process gas nozzle 20 takes place via a process gas store 22 which is a distance away from the optical carriage 7 and present on the transport vehicle 35 and which is connected to the process gas nozzle 20 via a process gas line 21 which is led via the tube bundle 50 to the orbital carriage 7. Particularly suitable process gasses are inert and active gases, such as, for example, preferably argon, helium, N₂, CO₂ or O₂, in a suitable mixing ratio. A wire nozzle 23 for supplying a wire 24 into the laser welding zone is also mounted indirectly on the optical carriage 7, on the other side of the laser welding head 12. By the supply of the wire 24 and the consequent introduction of a filler material it is possible to increase the gap bridging ability of the circumferential joint 3. The wire 24 is fed from a wire feed unit 26 housed on the transport vehicle 35 via a wire feed line 25 which reaches the orbital carriage 7 via the tube bundle 50. For heating the wire 24, a wire heating unit 27 which heats the wire 24, for example inductively, is arranged immediately before the wire nozzle 23. Instead of a hot wire it is possible preferably to feed an unheated cold wire as an alternative. In the working example shown, the wire 24 is trailed. Alternatively, it is also possible to realise penetrative or lateral wire feed. Instead of a separate process gas nozzle 20, the process gas supply can be effected coaxially with the laser beam or via the wire nozzle 23. The process gas nozzle 20 and the wire nozzle 23 are alternatively mounted directly on the orbital carriage 7 and can be aligned relative to it in at least 1 degree of freedom.

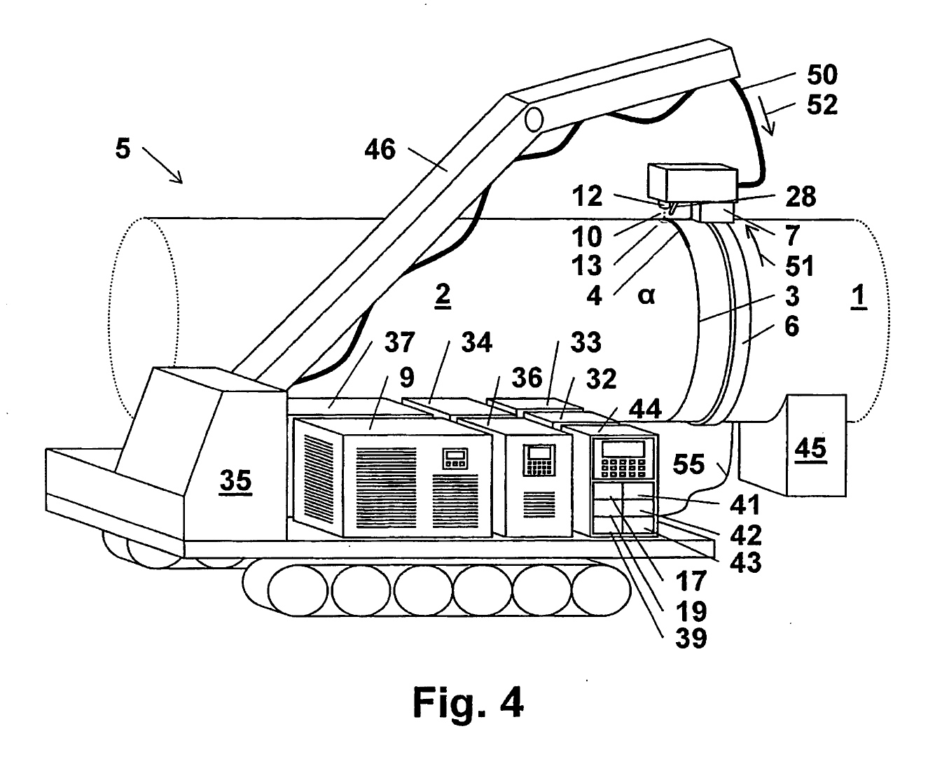

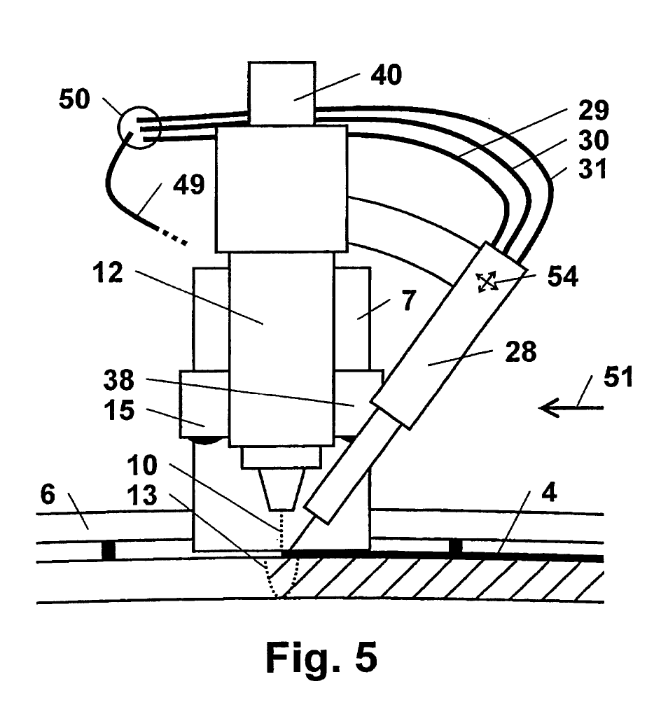

A second embodiment of an orbital welding device is shown in FIG. 4 in an oblique overview of the entire device, and in FIG. 5 in a detailed view parallel to the pipe axis onto the orbital carriage. Below, FIGS. 4 and 5 are described together, only the differences compared with the first embodiment being discussed, and reference is therefore hereby made to the reference numerals explained above. Instead of the supply of a wire 24 delivered from a wire feed unit 26 via a wire feed line 25 through a wire nozzle 23 and of a process gas passed from a process gas store 22 via a process gas line 21 to a process gas nozzle 20, a metal shielding gas arc welding head 28 known from the prior art is used. The MSG arc welding head 28 is arranged indirectly on the orbital carriage 7 by mounting it on the laser welding head 12. The MSG arc welding head 28 can be aligned under motor power relative to the laser welding head 12 and hence relative to the orbital carriage 7 in a plurality of degrees of freedom, as indicated by means of the arrows 54. For supplying the MSG arc welding head 28, a freely programmable MSG power source 32, an MSG process gas store 33 and an MSG wire feed unit 34 are arranged on the transport vehicle 35 and are connected via an MSG power line 29, an MSG process gas line 30 and an MSG wire feed line 31 to the MSG arc welding head 28 for MSG arc formation and for MSG process gas supply and for MSG wire supply, respectively. The lines 28, 29, 30 are led via the tube bundle 50 to the orbital carriage 7. In addition an earth line 55 connects the first pipe end 1 and second pipe end 2 to the MSG power source 32. The MSG arc welding head 28 is oriented in such a way that the laser beam 10 and the MSG arc cooperate in the laser welding zone 13. Alternatively, however, it is possible to orient the MSG arc welding head 28 so that the laser beam 10 and the MSG arc act in separate process zones, the laser beam 10 preferably being ahead of the MSG arc. Alternatively, it is also possible to orient the laser beam 10 so as to follow the MSG arc. By the combination of laser welding with MSG arc welding, the welding speed can be further increased, the process stability improved, a filler material introduced via the MSG wire supply and a lower temperature gradient achieved, so that the tendency to harden is reduced. Furthermore, a greater gap bridging ability is achieved. The combination of laser welding with MSG arc welding is particularly advantageous when a significant increase in the welding speed is desirable or the use of larger amounts of filler material is required for metallurgical reasons, for reasons relating to gap filling or because of certain standards.

The control and monitoring of the entire welding process are effected by means of the control computer 44, which has a communication link via the communication line 49 to sensors and actuators of the orbital carriage 7, to the components arranged there and to the units present on the transport vehicle 35. For increasing the process reliability and the welding speed, a plurality of control, regulation, monitoring and logging means, which are described below, are integrated in the control computer 44. These means are in the form of, for example, either a cabled circuit or an appropriately programmed control/regulation device.

The control computer 44 has a first process parameter control 19 which is formed and connected via the control computer 44 to the orbital position sensor 18, the high-power fibre laser beam source 9, the MSG power source 32 and the feed device 8 in such a way that laser radiation parameters, MSG arc parameters and the speed of advance of the orbital carriage 7 can be automatically adapted as a function of the orbital position α of the orbital carriage 7. It is therefore possible to weld using different welding parameters, for example in the case of a vertical-down weld or vertical-up weld.

FIG. 5 shows a seam tracking sensor 15 which is mounted on the laser welding head 12 and runs ahead of the already formed or intended laser welding zone defined by the orientation of the laser beam 10, by means of which seam tracking sensor the position of the circumferential joint 3 relative to the intended laser welding zone 13 can be detected. The seam tracking sensor 15 is, for example, in the form of an optical sensor which detects the position of the circumferential joint 3 by means of triangulation. A signal of the seam tracking sensor 15 which is associated with the position is fed to the control computer 44 which is connected to the adjusting means 16. The control computer 44 has a position control 17 which is formed and is connected via the control computer 44 to the seam tracking sensor 15 and the adjusting means 16 in such a way that the orientation of the laser beam 10 and in particular of the MSG arc welding head 28 can be automatically regulated as a function of the detected position of the circumferential joint 3. Thus, the laser beam 10 is automatically oriented relative to the circumferential joint 3 so that a misalignment of the laser beam 10 and of the MSG arc can be avoided even when the guide ring 6 is not mounted exactly parallel to the circumferential joint 3 or the circumferential joint 3 is not straight.

Furthermore, a process sensor 40 is arranged on the laser welding head 12 so that electromagnetic radiation, in particular thermal radiation, optical radiation or plasma radiation, from the laser welding zone 13 can be detected by means of the process sensor 40. A second process parameter control 41, which is integrated in the control computer 44 is formed and is connected via the control computer to the process sensor 40, the high-power fibre laser beam source 9, the MSG power source 32, the feed device 8 and the adjusting means 16 in such a way that laser radiation parameters, MSG arc parameters, the speed of advance of the orbital carriage 7 and the orientation of the laser beam 10 can be automatically adapted as a function of the detected radiation.

Optical recordings of the weld seam 4 produced can be made by means of an optical seam quality sensor 38 which is likewise mounted on the laser welding head 12, follows the laser welding zone 13 and, for example, is in the form of an optical sensor. Logging means 39 which are connected via the control computer 44 to the seam quality sensor 38 for storage and optical playback of the recordings of the weld seam 4 produced are provided on the control computer 44 so that a further playback of the recorded welding process is possible after the welding process has been carried out. This is advantageous in particular for determining any defect in the weld seam 4, since rapid discovery of the site of the defect is possible with additional detection and recording of the orbital position α.

In a further development, image processing means 42 are also integrated in the control computer 44 and are formed there and connected by the control computer 44 to the logging means 39 in such a way that the recordings of the weld seam 4 produced can be electronically evaluated and an evaluation signal which is linked to the quality of the weld seam 4 can be output. In the case of a defect in the weld seam 4, the output or recording of an error message is thus possible. If appropriate, the welding process is stopped after output of the error message and a warning signal is output in order to permit rapid elimination of the error and to keep downtimes short.

A third process parameter control 43 likewise integrated in the control computer 44 is formed and is connected via the control computer 44 to the image processing means 42, the high-power fibre laser beam source 9, the MSG power source 32, the feed device 8 and the adjusting means 16 in such a way that laser radiation parameters, MSG arc parameters, the speed of advance of the orbital carriage 7 and the orientation of the laser beam 10 can be automatically adapted as a function of the evaluation signal. Insufficient quality of the weld seam 4 or weld seam defects can be counteracted automatically by means of this control by adaptation of process parameters.

Alternatively, instead of all three process parameter controls 19, 41, 43, it is possible to use any one or two of the three process parameter controls 19, 41, 43, since these are independent of one another.

The use of further sensors and controls for increasing the process reliability is of course possible. The various arrangements described above represent only one possible, non limiting embodiment. Thus, for example, instead of being arranged on the laser welding head 12 the sensors described can be arranged indirectly or directly also on other elements of the orbital carriage 7. Instead of a control computer 44 the use of a plurality of independent control or regulation units, which are present, for example, directly on the orbital carriage 7, is possible.

1. Orbital welding device for mobile use for joining a first pipe end (1) and a second pipe end (2) along a circumferential joint (3) by means of at least one weld seam (4), in particular for producing a pipeline (5) to be laid on land comprising at least
a guide ring (6) which can be oriented relative to the first pipe end (1) and the circumferential joint (3),
an orbital carriage (7) displaceably guided at least along a section of the guide ring (6),
a feed device (8) by means of which the orbital carriage (7) can be moved under motor power along the guide ring (6),
a welding head which is arranged on the orbital carriage (7) and can be aligned with the circumferential joint (3) so that, by moving the orbital carriage (7), the weld seam (4) can be produced at least along a section of the circumferential joint (3),
a connecting line and
a welding device—in particular a mobile welding device—which is a distance away from the orbital carriage (7) and is connected via the connecting line to the welding head and indirectly or directly provides the power required for producing the weld seam (4),
characterized in that
the welding device is in the form of a high-power fibre laser beam source (9), by means of which a laser beam (10) can be produced,
the connecting line is in the form of a waveguide (11) for guiding the laser beam (10) to the orbital carriage (7) and
the welding head is in the form of a laser welding head (12) for directing the laser beam (10) into a laser welding zone (13) and for the consequent production of the weld seam (4).

2. Orbital welding device according to claim 1, characterized in that
the guide ring (6) is designed so as to be capable of being arranged on the outer surface (14) of the first pipe end (1) and
the weld seam which can be produced is in the form of an outer weld seam (4).

3. Orbital welding device according to claim 1, characterized by at least
a process gas nozzle (20) arranged indirectly or directly on the orbital carriage (7) and intended for supplying process gas to the region of the laser welding zone (13),
a process gas line (21) and
a process gas store (22)—in particular mobile process gas store—which is a distance away from the orbital carriage (7) and is connected via the process gas line (21) to the process gas nozzle (20) for the supply of process gas.

4. Orbital welding device according to claim 1, characterized by at least
a wire nozzle (23) arranged indirectly or directly on the orbital carriage (7) and intended for supplying a wire (24) into the laser welding zone (13),
a wire feed line (25) and
a wire feed unit (26)—in particular a mobile wire feed unit—which is a distance away from the orbital carriage (7) and is connected via the wire feed line (25) to the wire nozzle (23) for supplying wire.

5. Orbital welding device according to claim 4, characterized by a wire heating unit (27) located upstream of the wire nozzle (23) and intended for heating the wire (24).

6. Orbital welding device according to claim 1, characterized by at least
an MSG arc welding head (28) which is arranged indirectly or directly on the orbital carriage (7) and can be aligned under motor power in particular relative to the orbital carriage (7),
an MSG power line (29),
an MSG process gas store (30),
an MSG wire feed line (31),
an MSG power source (32)—in particular a mobile and freely programmable MSG power source—which is a distance away from the orbital carriage (7) and is connected via the MSG power line (29) to the MSG arc welding head (28) for forming the MSG arc,
an MSG process gas store (30)—in particular mobile MSG process gas store—which is a distance away from the orbital carriage (7) and is connected via the MSG processing gas line (30) to the MSG arc welding head (28) for supplying the MSG process gas, and
an MSG wire feed unit (34)—in particular mobile MSG wire feed unit—which is a distance away from the orbital carriage (30) and is connected via the MSG wire feed line (31) to the MSG arc welding head (28) for supplying the MSG wire.

7. Orbital welding device according to claim 6, characterized in that the MSG arc welding head (26) is arranged indirectly or directly on the orbital carriage (7) in such a way that the laser beam (10) and the MSG arc cooperate in the laser welding zone (13).

8. Orbital welding device according to claim 6, characterized in that the MSG arc welding head (28) is arranged indirectly or directly on the orbital carriage (7) in such a way that the laser beam (10) and the MSG arc act in separate process zones.

9. Orbital welding device according to claim 1 characterized by
an orbital position sensor (18) for detecting the orbital position (α) of the orbital carriage (7) and
a first process parameter control (19) which is formed and is connected to the orbital position sensor (18) and at least to the high-power fibre laser beam source (9)—and in particular to the MSG power source (32) and the feed device (8)—in such a way that laser radiation parameters—and in particular MSG arc parameters and the speed of advance of the orbital carriage (7)—can be automatically adapted as a function of the orbital position (α) of the orbital carriage (7).

10. Orbital welding device according to claim 1, characterized by
a seam tracking sensor (15) which is arranged indirectly or directly on the orbital carriage (7)—in particular so as to be ahead of the intended laser welding zone (13)—in such a way that the position of the circumferential joint (3) relative to the intended laser welding zone (13) can be detected,
adjusting means (16) by means of which the laser beam (10)—and in particular the wire nozzle (23) or the MSG arc welding head (28)—can be oriented relative to the circumferential joint (3), and
a position control (17) which is formed and is connected to the seam tracking sensor (15) and the adjusting means (16) in such a way that the orientation of the laser beam (10)—and in particular of the wire nozzle (23) or of the MSG arc welding head (28) can be automatically regulated as a function of the detected position of the circumferential joint (3).

11. Orbital welding device according to claim 1, characterized by
a process sensor (40) arranged indirectly or directly on the orbital carriage (7)—in particular on the laser welding head (12)—in such a way that electromagnetic radiation—in particular thermal radiation, optical radiation or plasma radiation—from the laser welding zone (13) can be detected, and
a second process parameter control (41) which is formed and is connected to the process sensor (40) and at least the high-power fibre laser beam source (9)—and in particular to the MSG power source (32), the feed device (8) and the adjusting means (16)—in such a way that laser radiation parameters—and in particular MSG arc parameters, the speed of advance of the orbital carriage (7) and the orientation of the laser beam (10)—can be automatically adapted as a function of the detected radiation.

12. Orbital welding device according to claim 1, characterized by
an optical seam quality sensor (38) arranged indirectly or directly on the orbital carriage (7), tracking the laser welding zone (13) and intended for making optical recordings of the weld seam (4) produced and
logging means (39) which are connected to the seam quality sensor (38) for storage and optical playback of the recordings of the weld seam (4) produced.

13. Orbital welding device according to claim 12, characterized by image processing means (42) which are formed and are connected to the logging means (39) in such a way that the recordings of the weld seam (4) produced can be electronically evaluated and an evaluation signal which is associated with the quality of the weld seam (4) can be output.

14. Orbital welding device according to claim 13, characterized by a third process parameter control (43) which is formed and is connected at least to the image processing means (42) and the high-power fibre laser beam source (9)—and in particular to the MSG power source (32), the feed device (8) and the adjusting means (16)—in such a way that laser radiation parameters—and in particular MSG arc parameters, the speed of advance of the orbital carriage (7) and the orientation of the laser beam (10)—can be automatically adapted as a function of the evaluation signal.

15. Orbital welding device according to claim 1, characterized by a transport vehicle (35) which can be moved longitudinally under motor power outside the first pipe (1) and the second pipe (2) and on which at least
the high-power fibre laser beam source (9),
a generator (36) at least for generating the power required for operating the high-power fibre laser beam source (9) and
a cooling system (37), coordinated at least with the high-power fibre laser beam source (9),
and in particular
the process gas store (22),
the wire feed unit (26),
the MSG power source (32),
the MSG process gas store (33) and
the MSG wire feed unit (34)
are arranged so that the orbital welding device can be operated in a substantially stand-alone mobile manner.

16. Transport vehicle (35) of an orbital welding device according to claim 15, characterized in that
a high-power fibre laser beam source (9),
a generator (36) at least for generating the power required for operating the high-power fibre laser beam source (9) and
a cooling system (37) coordinated at least with the high-power fibre laser beam source (9)
are arranged on the transport vehicle (35).

17. Transport vehicle (35) according to claim 16, characterized in that
a process gas store (22) and
a wire feed unit (26) are arranged on the transport vehicle (35).

18. Transport vehicle (35) according to claim 16, characterized in that
an MSG power source (32),
an MSG process gas store (33) and
an MSG wire feed unit (34)
are arranged on the transport vehicle (35).
